(19) United States
(12) Patent Application Publication
(10) Pub. No.: US 2020/0145478 A1
(43) Pub. Date: May 7, 2020

(54) METHOD, ELECTRONIC DEVICE, AND COMPUTER PROGRAM PRODUCT FOR HANDLING CONGESTION OF DATA TRANSMISSION

(71) Applicant: EMC IP Holding Company LLC, Hopkinton, MA (US)

(72) Inventors: Wayne Gao, Shanghai (CN); Kang Zhang, Shanghai (CN); Gary Jialei Wu, Shanghai (CN); Ao Sun, Shanghai (CN)

(21) Appl. No.: 16/442,369

(22) Filed: Jun. 14, 2019

(30) Foreign Application Priority Data
Nov. 2, 2018 (CN) 201811300794.8

(51) Int. Cl. H04L 29/08; H04L 12/801

(52) U.S. Cl. CPC H04L 67/101; H04L 47/11; H04L 67/1097

(57) ABSTRACT

Embodiments of the present disclosure provide a method, electronic device and computer program product for handling congestion of data transmission. The method comprises determining whether congestion caused by a plurality of storage nodes occurs at a first port of a switch, the first port being connected to a first storage node, the plurality of storage nodes transmitting data to the first storage node via the first port of the switch. The method further comprises in response to determining that the congestion occurs at the first port, selecting at least a second storage node from the plurality of storage nodes. The method further comprises updating configuration of a data transmission path for the second storage node, such that the second storage node transmits data to the first storage node while bypassing the first port. By means of the embodiments of the present disclosure, the efficiency of data transmission between storage nodes is increased, which helps to improve the overall performance of a storage system.

### RELATED APPLICATION

The present application claims the benefit of priority to Chinese Patent Application No. 201811300794.8, filed on Nov. 2, 2018, which application is hereby incorporated into the present application by reference herein in its entirety.

### FIELD

Embodiments of the present disclosure relate to the field of data storage, and more specifically, to a method, electronic device and computer program product for handling congestion of data transmission.

### BACKGROUND

More and more distributed storage systems are used in various data centers. In a distributed storage system, each storage node transmits data through a network based on the Transmission Control Protocol (TCP). When an end user reads data, there exists such a circumstance that a plurality of data nodes simultaneously send data back to the client node. This many-to-one traffic pattern is also called incast, which is common in data center applications. The presence of incast often causes network congestion, which reduces the performance of distributed storage systems.

### SUMMARY

Embodiments of the present disclosure provide a solution for handling congestion of data transmission.

In a first aspect of the present disclosure, there is provided a method for handling congestion of data transmission. The method comprises: determining whether a congestion caused by a plurality of storage nodes occurs at a first port of a switch, the first port being connected to a first storage node, the plurality of storage nodes transmitting data to the first storage node via the first port of the switch. The method also comprises in response to determining that the congestion occurs at the first port, selecting at least a second storage node from the plurality of storage nodes. The method further comprises updating configuration of a data transmission path for the second storage node, such that the second storage node transmits data to the first storage node while bypassing the first port.

In a second aspect of the present disclosure, there is provided an electronic device. The electronic device comprises a processor and a memory coupled to the processor, the memory having instructions stored therein, the instructions, when executed by the processor, causing the electronic device to perform acts. The acts comprise determining whether a congestion caused by a plurality of storage nodes occurs at a first port of a switch, the first port being connected to a first storage node, the plurality of storage nodes transmitting data to the first storage node via the first port of the switch. The acts further comprise in response to determining that the congestion occurs at the first port, selecting at least a second storage node from the plurality of storage nodes. The acts further comprise updating configuration of a data transmission path for the second storage node, such that the second storage node transmits data to the first storage node while bypassing the first port.

In a third aspect of the present disclosure, there is provided a computer program product. The computer program product is tangibly stored on a computer readable medium and comprises machine executable instructions which, when executed, cause the machine to perform a method according to the first aspect of the present disclosure.

The Summary is provided to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

The above and other objectives, features, and advantages of the present disclosure will become more apparent through the following more detailed description of the example embodiments of the present disclosure with reference to the accompanying drawings, wherein the same reference sign generally refers to the like element in the example embodiments of the present disclosure.

FIG. 1 shows a schematic diagram of an example environment in which embodiments of the present disclosure can be implemented;

FIG. 2 shows a flowchart of a process of handling congestion of data transmission according to embodiments of the present disclosure;

FIG. 3 shows a schematic diagram of obtaining transmission control information according to some embodiments of the present disclosure;

FIG. 4 shows a flowchart of a process of determining congestion according to some embodiments of the present disclosure;

FIG. 5 shows a schematic diagram of transmitting data while bypassing a first port according to some embodiments of the present disclosure;

FIG. 6 shows a schematic diagram of a circular transmission path according to some embodiments of the present disclosure;

FIG. 7 shows a schematic diagram of a circular transmission path according to some other embodiments of the present disclosure; and

FIG. 8 shows a block diagram of an example device that can be used to implement embodiments of the present disclosure.

### DETAILED DESCRIPTION OF EMBODIMENTS

Principles of the present disclosure will now be described with reference to several example embodiments illustrated in the drawings. Although some preferred embodiments of the present disclosure are shown in the drawings, it would be appreciated that description of those embodiments is merely for the purpose of enabling those skilled in the art to better understand and further implement the present disclosure and is not intended for limiting the scope disclosed herein in any manner.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The terms “an example embodiment” and “an embodiment” are to be read as “at least one example embodiment.” The term “another embodiment” is to be read as “at least one further embodiment.” The terms “first”, “second” and so on can refer to same or different objects. Other definitions, either explicit or implicit, may be included below.

As mentioned above, in a distributed storage system there exists incast (also referred to as TCP incast) where a plurality of sender nodes transmit data to one receiver node. When TCP incast occurs and causes network congestion (abbreviated as congestion below), the switch between the sender node and the receiver node drops packets a lot. Actually, TCP incast is even worse than what is imagined. Most switches cannot handle TCP incast very well even with cut through forwarding mode for low latency. Table 1 shows test data of a switch under the presence of TCP incast, wherein “In Packet loss” represents the number of packets lost per second. As can be seen, even though the output network interface controller (NIC) of the switch still has half available bandwidth, packets start to drop aggressively on the input NIC of the switch.

TABLE 1
Test Data of Switch under TCP Incast

| | In NIC | In NIC | Out NIC | Out NIC | |
|---|---|---|---|---|---|
| | bandwidth | usage | bandwidth | usage | In Packet |
| Port | (Mbps) | (%) | (Mbps) | (%) | losss |
| Et9 | 4993.1 | 50.6 | 239.5 | 2.5 | 259 |
| Et10 | 5987.7 | 60.7 | 4783.1 | 48.5 | 239 |
| Et11 | 4958.9 | 50.3 | 2659.4 | 27.0 | 405 |
| Et12 | 7461.0 | 75.6 | 1651.6 | 16.8 | 152 |

The switches have different capabilities of handling TCP incast, but they are all doing very well if there is no TCP incast. By contrast, Table 2 shows test data of a switch without TCP incast. As seen from Table 2, the network throughput for transmission/reception is much higher than the incast situation in Table 1 without any packet loss.

TABLE 2
Test Data of Switch without TCP Incast

| | In NIC | In NIC | Out NIC | Out NIC | |
|---|---|---|---|---|---|
| | bandwidth | usage | bandwidth | usage | In Packet |
| Port | (Mbps) | (%) | (Mbps) | (%) | losss |
| Et9 | 5593.0 | 56.7 | 5178.1 | 52.5 | 0 |
| Et10 | 5178.5 | 52.5 | 5593.4 | 56.7 | 0 |
| Et11 | 5016.1 | 50.8 | 5396.0 | 54.7 | 0 |
| Et12 | 5397.7 | 54.7 | 5018.4 | 50.8 | 0 |

TCP itself controls throughput via the TCP congestion control protocol, while the sender and receiver do not know the state of each other until they get acknowledgment with window update or zero window from the peer. The speed of data flow is also affected by many other factors such as application receiving speed, acknowledgment speed to the sender and estimate of sender congestion window, etc. When the performance degrades, it is too complex for engineers to figure out why the flow becomes slow.

In conventional implementation, when a problem occurs, the following methods are usually used to figure out the problem in the storage system: (1) Check the application server log. If there is really a network error, sometimes the log will give some hint but probably will not provide more information, e.g. incast is ongoing. (2) Use ss/netstat/iftop to roughly check network situation. (3) Use tcpdump to capture packets for wireshark to analysis. However, it is not easy to narrow down the problems quickly. These tools are not as accurate as expected, and a final judgement needs to be made with experience. (4) Login on the switch to check a counter, such as a drop counter.

However, the inventors have realized that there are several problems in such implementations. None of the above approaches use the logic inside the TCP. Especially all the trouble shooting steps are done manually and are time consuming. Therefore, with the conventional troubleshooting approaches, it is hard to know real problems that occur on the network path and software stack, and it is difficult to make a concrete analysis. Due to the congestion caused by TCP incast, the network becomes the performance bottleneck of distributed systems under a high load.

The present disclosure provides a solution for handling congestion of data transmission so as to at least eliminate one or more of the above drawbacks. By monitoring states of a switch and a plurality of storage nodes in a distributed storage system in real, it may be determined whether network congestion occurs at a port of the switch. When it is determined that congestion occurs at a certain port, at least one storage node is selected from storage nodes that transmit data via the certain port. Then, by updating configuration of a data transmission path for the selected storage node, the selected storage node is caused to transmit data while bypassing the congested port. In embodiments of the present disclosure, a congested portion in the storage system may be determined accurately, and a data transmission path may be controlled dynamically. In this way, more intelligent resource allocation is achieved and the data transmission efficiency between storage nodes is increased, thus improving the overall performance of the storage system.

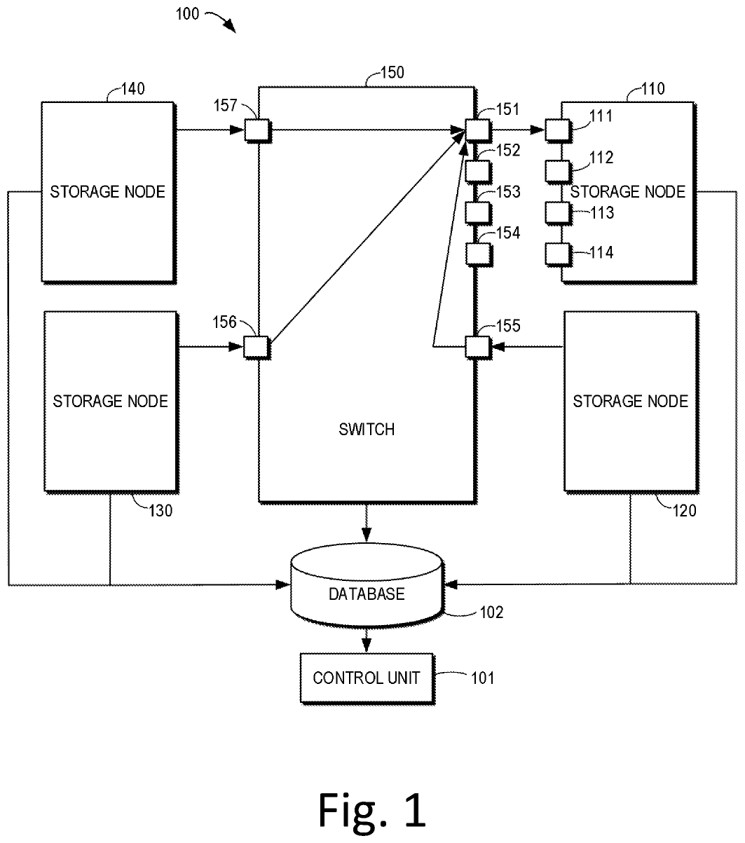

Embodiments of the present disclosure are described in detail below with reference to the accompanying drawings. FIG. 1 shows a schematic diagram of an example environment 100 in which embodiments of the present disclosure may be implemented. In the example environment 100 shown in FIG. 1, the distributed storage system comprises storage nodes 110, 120, 130 and 140, as well as a switch 150. When a user's data request is received, the storage nodes 110, 120, 130 and 140 may transmit data to one another via the switch 150. It should be understood that the respective numbers of storage nodes and switches shown in FIG. 1 are merely illustrative and not intended to limit the scope of the present disclosure. Embodiments of the present disclosure may be applied to a system comprising any number of nodes and switches.

Ports 151-157 are arranged on the switch 150. These ports are connected to the storage nodes 110, 120, 130 and 140 respectively, e.g., connected through the NIC on the storage nodes. In the example of FIG. 1, the ports 151-154 are connected to the storage node 110 through NICs 111-114 respectively. The ports 155-157 are connected to the storage nodes 120, 130 and 140 respectively (for the sake of clarity, NICs on the storage nodes 120, 130 and 140 are not shown). It should be understood that the NICs on the storage nodes shown herein is merely exemplary, and the storage nodes may also be connected to the switch through any apparatus or device that can implement a network connection.

Note that the numbers of ports and NICs shown in FIG. 1 are merely exemplary and not intended to limit the scope of the present disclosure. The switch 150 may have more or less ports and may have a port that is not connected to any storage node. The storage nodes 110, 120, 130 and 140 may also have more or less NICs and may be connected to the switch 150 through NICs. In addition, although not shown, the switch 150 may have ports which are connected to the storage nodes 120, 130 and 140 respectively, in addition to the ports 155-157.

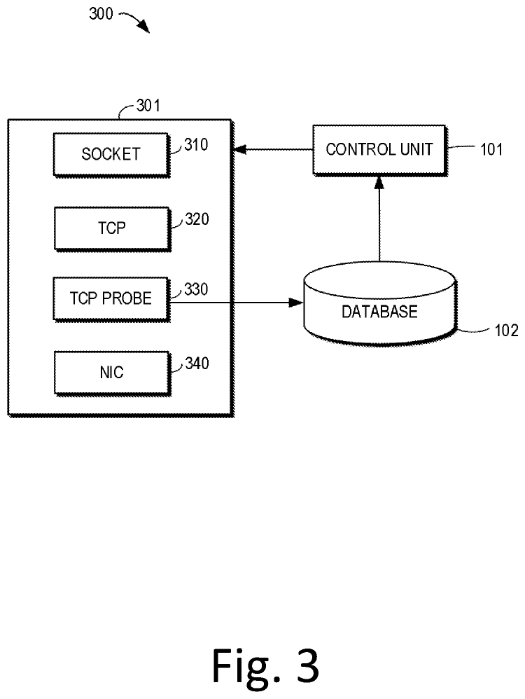

In order to monitor in real-time the data transmission situation of each storage node and the state of the switch, a database 102 may be used in the storage system. The database 102 may be a time series database such as CloudDB. Of course, this is merely an example, and any database that can store time series data or receive data output in stream may be used in conjunction with embodiments of the present disclosure. Information (e.g. TCP information) of the storage nodes 110, 120, 130 and 140 related to transmission control will be streamed-output to the database 102 (will be described in detail with reference to FIG. 3). Operation parameters of the switch, such as NIC bandwidth, usage and packet loss data as list in Tables 1 and 2, may also be streamed to the database 102.

A control unit 101 may make analysis with information in the database 102 so as to determine whether congest occurs at a port of the switch 150. In the example of FIG. 1, the storage nodes 120, 130 and 140 each transmit data to the storage node 110 via the port 151. Therefore, congestion might occur at the port 151. The control unit 101 may redirect part of data traffic from the storage nodes 120, 130 and 140 to other ports of the switch 150 or otherwise bypass the port 151.

Although it is shown that parameters related to the state of the switch 150 are output to the database 102, the control unit 101 may also obtain operation parameters from the switch 150 directly. The control unit 101 may be deployed on a dedicated computing device (e.g. dedicated server) or any storage node. No matter how the control unit 101 is deployed, the control unit 101 may communicate with each of the storage nodes 110, 120, 130 and 140 to update configuration of a data transmission path for the storage node.

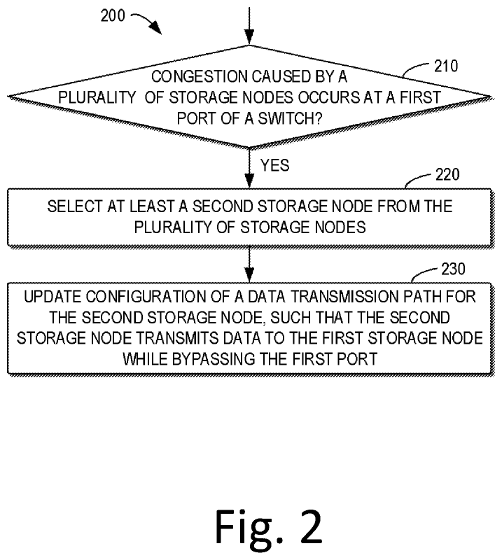

Embodiments of the present disclosure are described in detail with reference to FIGS. 2-7. FIG. 2 shows a flowchart of a process 200 of handling congestion of data transmission according to embodiments of the present disclosure. The process 200 may be implemented by the control unit 101 or at the switch 150. Regarding the cases where the process 200 is implemented by the control unit 101, various commercial switches may be used without any modification, thereby having wide applicability. For the sake of discussion, the process 200 is described in conjunction with FIG. 1 as being implemented by the control unit 101. The control unit 101 monitors and analyzes each port of the switch 150, such as the port 151, by using information and parameters from the database 102.

At block 210, the control unit 101 determines whether congestion caused by a plurality of storage nodes occurs at the first port 151 of the switch 150. For example, in the example of FIG. 1, the first port 151 is connected to the storage node 110 (referred to as the first storage node below), and the storage nodes 120, 130 and 140 (referred to as a plurality of storage nodes below) transmit data to the first storage node 110 via the first port 151 of the switch 150. It should be understood that although not shown, the storage system may further comprise a storage node that transmits data to the first storage node 110 without via the first port 151.

As mentioned above, since congestion per se is a complex issue, the control unit 101 needs to determine the congestion at the first port 151 in conjunction with factors of the switch and the storage node. For example, if the congestion window of a socket of a certain storage node decreases while a drop counter of the switch keeps growing, it may be considered that congestion occurs in the storage system.

The control unit 101 may obtain parameters related to the state of the switch 150, such as operation parameters of the ports 151-157. Such operation parameters may comprise the input NIC bandwidth, input NIC usage, output NIC bandwidth, output NIC usage and input packet loss of ports as list in Tables 1 and 2.

The control unit 101 further needs to obtain and analyze information on the transmission control of the storage nodes 110, 120, 130 and 140. FIG. 3 shows a schematic diagram of obtaining transmission control information according to some embodiments of the present disclosure. For any one of the storage nodes 110, 120, 130 and 140, a kernel 301 may comprise modules including a socket 301, TCP 320, a TCP probe 330, NIC 340, etc.

The TCP probe 330 may streaming-output information (e.g. TCP information) on the transmission control of a storage node to the time series database 102. Information output by the TCP probe 330 may comprise parameters, such as a congestion window (cwnd) and acknowledgment/sequence (ack/seq). In addition, other critical information such as netsta counter and the like may also be output to the database 102. The TCP probe 330 may be dynamically enabled or disabled based on different policies, in order to reduce side effects of the TCP probe 330.

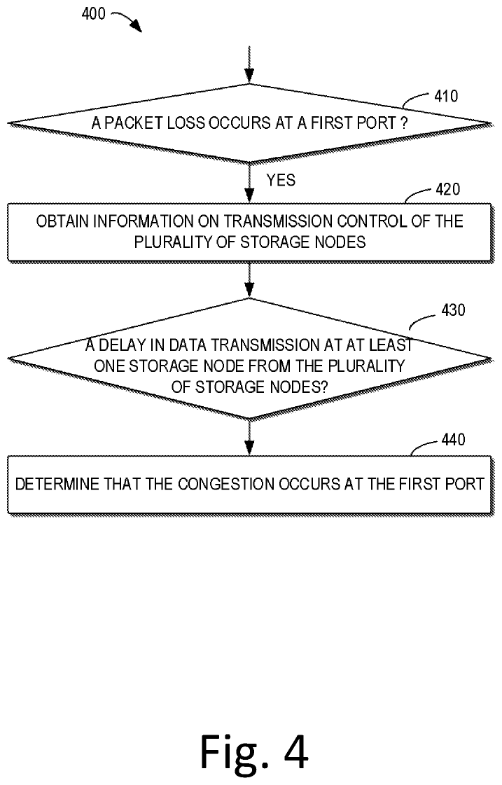

The information mentioned above is merely exemplary, and embodiments of the present disclosure may utilize any information related to the switch and storage nodes. The control unit 101 may utilize and analyze such information in the database 102 in real time so as to determine whether congestion occurs at a port of the switch 150. FIG. 4 shows a flowchart of a process 400 of determining congestion according to some embodiments of the present disclosure. The process 400 may be regarded as a specific implementation of block 210 in FIG. 2.

At block 410, the control unit 101 determines whether a packet loss occurs at the first port 151 based on operation parameters of the first port 151. For example, if the control unit 101 determines from operation parameters output from the switch 150 to the database 102 that the parameter “in packet loss” of the first port 151 is not zero, then the control unit 101 may determine a packet loss at the first port 151.

If the control unit 101 determines the packet loss at the first port 151, then the process 400 proceeds to block 420. The control unit 101 may determine, using information in the database 101, that the storage nodes 120, 130 and 140 are transmitting data to the first storage node 110 via the first port 151.

At block 420, the control unit 101 obtains (e.g. from the database 102) information on transmission control of the plurality of storage nodes 120, 130 and 140. At block 430, the control unit 101 determines whether such information indicates a delay in data transmission at at least one of the plurality of storage nodes 120, 130 and 140. If the control unit 101 determines that the delay in data transmission occurs at at least one (e.g. storage node 130) of the plurality of storage nodes 120, 130 and 140, then the process 400 may proceed to block 440. At block 440, the control unit 101 determines that the congestion occurs at the first port 151.

In some embodiments, the information obtained at block 420 comprises a congestion window, the reduction of which means a delay in data transmission. In such embodiments, the control unit 101 may determine at block 430 whether the congestion window for the storage nodes 120, 130 and 140 is reduced. If the congestion window for at least one (e.g. storage node 130) of the storage nodes 120, 130 and 140 is reduced, then the control unit 101 may determine at block 440 that the congestion occurs at the first port 151.

In some embodiments, the information obtained at block 420 may further comprise other information or parameter that can be used to indicate a delay in data transmission. For example, such information may indicate whether repeated acknowledgments (ACK) are received from the receiver (the first storage node 110 in this example).

Due to the complexity of congestion, it is hard to determine the occurrence of congestion only based on the operation states of the switch or the storage node. Therefore, in embodiments of the present disclosure, the occurrence of congestion and a port where the congestion occurs may be determined accurately in this way.

Still referring to FIG. 2. If it is determined at block 210 that the congestion occurs at the first port 151, then the process 200 proceeds to block 220. At block 220, the control unit 101 selects at least one storage node (e.g. storage node 120) from the plurality of storage nodes 120, 130 and 140, wherein data of the selected storage node will be transmitted while bypassing the first port 151. For the sake of discussion, the selected storage node is referred to as a second storage node below.

The control unit 101 may select any storage node from the plurality of storage nodes 120, 130 and 140 or select the second storage node based on data traffic. The control unit 101 may determine data traffic transmitted from each of the plurality of storage nodes 120, 130 and 140. For example, the control unit 101 may determine data traffic using information in the database 102.

In some embodiments, the control unit 101 may select a storage node with the largest data traffic from the plurality of storage nodes 120, 130 and 140 as the second storage node. In some embodiments, the control unit 101 may select a storage node with the second highest data traffic as the second storage node. In such embodiments, by changing a transmission path for larger data traffic, the data transmission load of a port where the congestion occurs may be reduced effectively, which helps to improve the transmission efficiency.

In some other embodiments, the control unit 101 may select more than one storage node from the plurality of storage nodes 120, 130 and 140, such that data of these storage nodes are transmitted while bypassing the first port 151, and new data transmission paths for these storage nodes may be different. Therefore, in such embodiments, the data transmission efficiency of a port where the congestion occurs may be improved further.

For the sake of discussion, suppose that the control unit 101 at least selects the storage node 120 (referred to as the second storage node 120 below) at block 220. Then, at block 230, the control unit 101 updates configuration of a data transmission path for the second storage node 120, such that the second storage node 120 transmits data to the first storage node 110 while bypassing the first port 151. The control unit 101 may send the updated configuration to the second storage node in the form of a message, or deliver the updated configuration to the second storage node 120 by other means such as remote procedure call (RPC). Embodiments of the present disclosure are not limited in this regard.

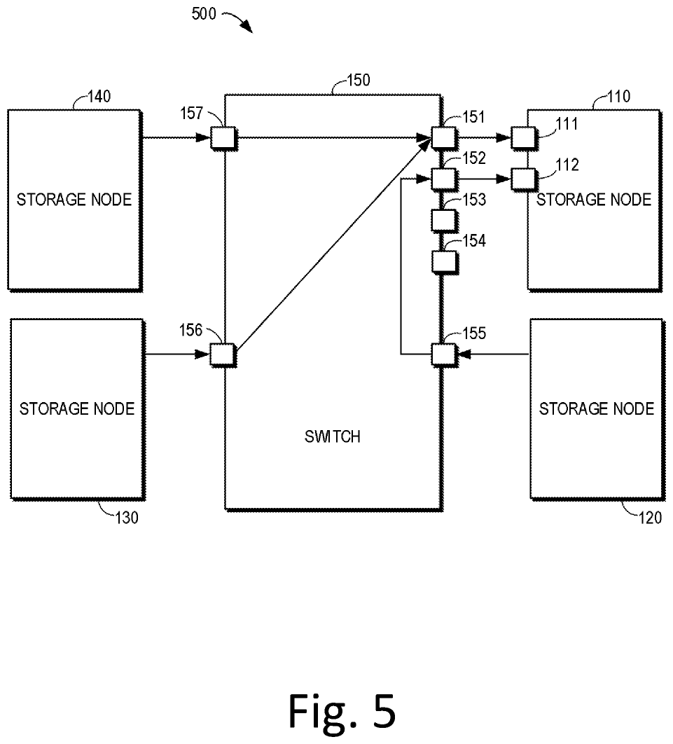

In some embodiments, the control unit 101 may update configuration of a data transmission path for the second storage node 120, such that the second storage node 120 transmits data to the first storage node 110 via another port of the switch 150. Such embodiments are described with reference to FIG. 5 below.

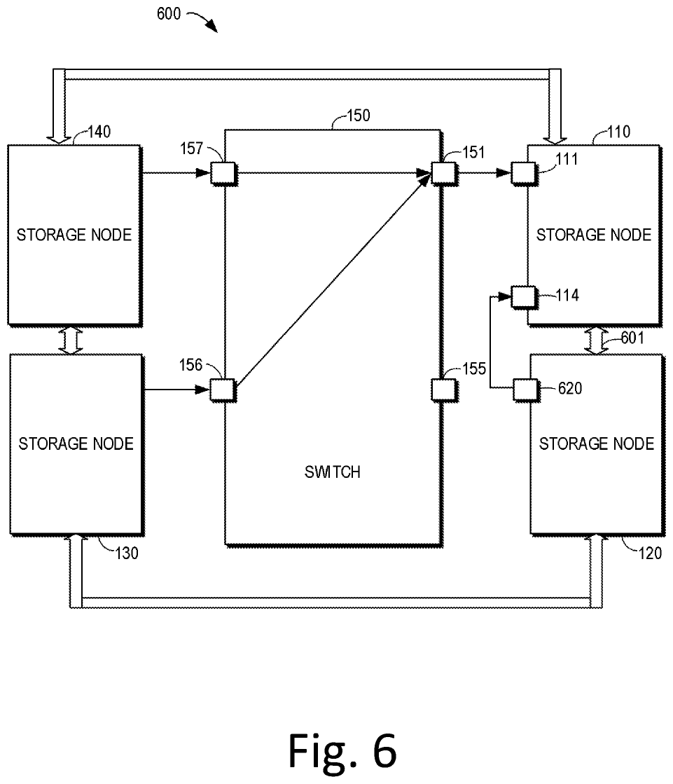

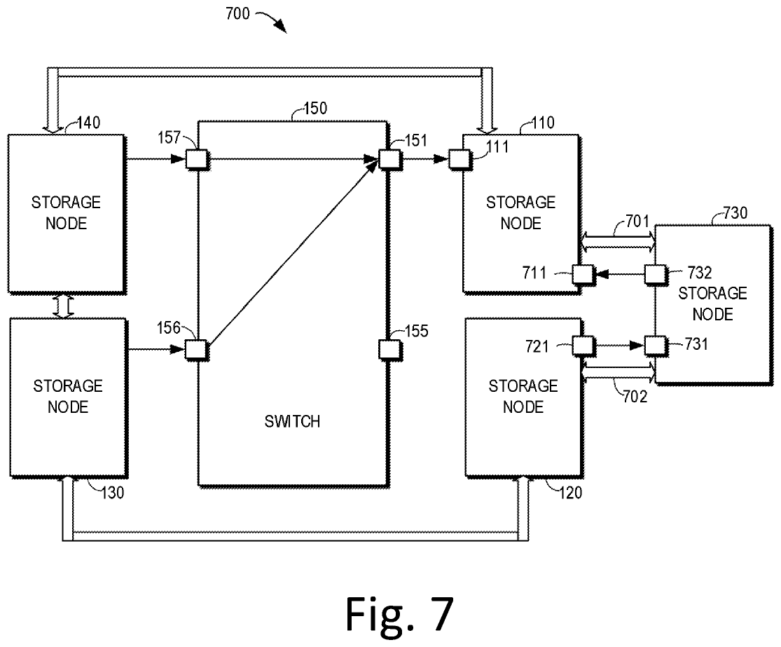

In some embodiments, all or some of the storage nodes 110, 120, 130 and 140 may be connected together, such that data may be transmitted to an adjacent storage node directly or relayed to a destination storage node via an adjacent storage node. In such embodiments, the control unit 101 may update configuration of a data transmission path for the second storage node 120, such that the second storage node 120 transmits data to the first storage node 110 while bypassing the switch 150. Such embodiments are described with reference to FIGS. 6 and 7 below.

In embodiments of the present disclosure, by monitoring operation states of the switch and storage nodes, congestion occurring at a port of the switch may be determined, and part of data traffic causing the congestion may be redirected to other paths. In this way, the congestion of data transmission may be reduced, and the data transmission efficiency may be increased, which helps to improve the overall performance of the storage system.

As mentioned above, the congestion at the first port 151 may be handled by causing the second storage node 120 to transmit data to the first storage node 110 via another port of the switch 150. Such embodiments are now described with reference to FIG. 5. FIG. 5 shows a schematic diagram 500 of transmitting data while bypassing a first port according to some embodiments of the present disclosure.

The control unit 101 may select a free port from a plurality of ports of the switch 150 which are connected to the first storage node 110. Specifically, the control unit 101 may select a second port from the plurality of ports 152-154 based on resource usages of the plurality of ports 152-154 of the switch 151. For example, in the example of FIG. 5, the second control 101 selects the second port 152.

Subsequently, the control unit 101 may deactivate the connection of the second storage node 120 to the first port 151 and activate the connection of the second storage node 120 to the second port 120, such that the second storage node 120 transmits data to the first storage node via the second port 152. For example, the control unit 101 may implement the deactivation and activation by modifying the configuration of the socket of the second storage node 120.

The control unit 101 may determine a network address (e.g. IP address) allocated to the NIC 112 of the first storage node 110 to which the second port 152 is connected, and update the destination address of the socket of the second storage node 120 as the IP address allocated to the NIC 112. For the network bonding NIC, the control unit 101 may implement the activation of the connection to the second port 152 and the deactivation of the connection to the first port 151 by simply changing the port number of the socket of the second storage node 120.

As mentioned above, the second storage node 120 may be caused to transmit data to the first storage node 110 while bypassing the switch 150. Such embodiments will now be described with reference to FIGS. 6 and 7. FIG. 6 shows a schematic diagram 600 of a circular transmission path according to some embodiments of the present disclosure.

As shown in FIG. 6, the storage nodes 110, 120, 130 and 140 of the storage system may be serially connected together, e.g. to form a circular loop. It should be understood that the connections between the storage nodes 110, 120, 130 and 140 shown in FIG. 6 are merely illustrative, and the storage system may further comprise other storage node, e.g. a storage node connected between the storage node 110 and the storage node 140.

In some embodiments, the connection between the storage nodes 110, 120, 130 and 140 may be implemented by for example a NIC (including normal NIC and smart NIC) or field programmable gate array (FGPA). For example, in the example of FIG. 6, a direct connection 601 between the first storage node 110 and the second storage node 120 may be implemented by the connection between the NIC 114 of the first storage node 110 and the NIC 620 of the second storage node 120.

For the example of FIG. 6, the control unit 101 may determine that there is a direct connection 601 between the first storage node 110 and the second storage node 120. The control unit 101 may then deactivate the connection between the second storage node 120 and the switch 150, and activate the direct connection 601 between the second storage node 120 and the first storage node 110, such that the second storage node 120 transmits data to the first storage node 110 directly. Therefore, in the example of FIG. 6, after the configuration is updated, data from the second storage node 120 will be transmitted to the first storage node 110 via the NIC 620 and the NIC 114.

The control unit 101 may implement the deactivation and activation by modifying the configuration of the socket of the second storage node 120. In the example of FIG. 6, the direct connection 601 is implemented by the connection between the NIC 114 of the first storage node 110 and the NIC 620 of the second storage node 120. Therefore, the control unit 101 may update a source address of the socket of the second storage node 120 as an IP address allocated to the NIC 620, and update a destination address of the socket of the second storage node 120 as an IP address allocated to the NIC 114. As mentioned with reference to FIG. 5, for the network bonding NIC, the control unit 101 may implement the activation of the direct connection 601 and the deactivation of the connection to the first port 151 by simply changing the port number of the socket of the second storage node 120.

FIG. 7 shows a schematic diagram 700 of a circular transmission path according to some other embodiments of the present disclosure. Similar with the example of FIG. 6, in the example of FIG. 7, the storage nodes 110, 120, 130, 140 and 730 are serially connected to form a circular loop. As shown in FIG. 7, the first storage node 110 is not directly connected to the second storage node 120. There is a first direct connection 701 between the first storage node 110 and the storage node 730 (referred to as the third storage node 730 below), and there is a second direct connection 702 between the second storage node 120 and the third storage node 730.

In this case, the control unit 101 may deactivate the connection between the second storage node 120 and the switch, and activate the first direct connection 701 and the second direct connection 702, such that the third storage node 730 relays data from the second storage node 120 to the first storage node 110. Therefore, in the example of FIG. 7, after the configuration is updated, data from the second storage node 120 will be first transmitted to the third storage node 730 via NICs 721 and 731, and then forwarded to the first storage node 110 via NICs 732 and 711.

Similarly, the control unit 101 may implement the deactivation and activation by modifying configuration of the socket of the second storage node 120. In the example of FIG. 7, the first direct connection 701 is implemented by the connection between the NIC 711 of the first storage node 110 and the NIC 732 of the third storage node 730, and the second direct connection 702 is implemented by the connection between the NIC 721 of the second storage node 120 and the NIC 731 of the third storage node 730. Therefore, the control unit 101 may update a source address of the socket of the second storage node 120 as the IP address allocated to the NIC 721, and update a destination address of the socket of the second storage node 120 as the IP address allocated to the NIC 711. As mentioned with reference to FIG. 5, for the network bonding NIC, the control unit 101 may implement the activation of the first direct connection 701 and the second direct connection 702 and the deactivation of the connection to the first port 151 by simply changing a port number of the socket of the second storage node 120.

In the embodiments described with reference to FIGS. 6 and 7, an additional data transmission path may be created by serially connecting all or some of the storage nodes. In this way, the load of the switch in data transmission may be alleviated, which helps to further improve the performance of the storage system.

In cases shown in FIGS. 6 and 7, connections between the storage nodes may be implemented by normal NIC, smart NIC, FGPA, etc. With a normal NIC, data transmission across one node may be supported without any impact on the performance of the node. With a smart NIC, since a smart NIC has processing capability, data transmission across two or three nodes may be supported without any impact on the performance of nodes.

Where all or some of the storage nodes are serially connected, when data needs to be transmitted to an adjacent or nearby storage node, such a serial path may be preferentially selected for data transmission. For example, in the example of FIG. 7, when the storage node 120 is to transmit data to the storage node 110, the storage node 120 may select to transmit data to the storage node 730, such that the storage node 730 relays data to the storage node 110. In this way, the load of the switch in data transmission may be reduced as much as possible.

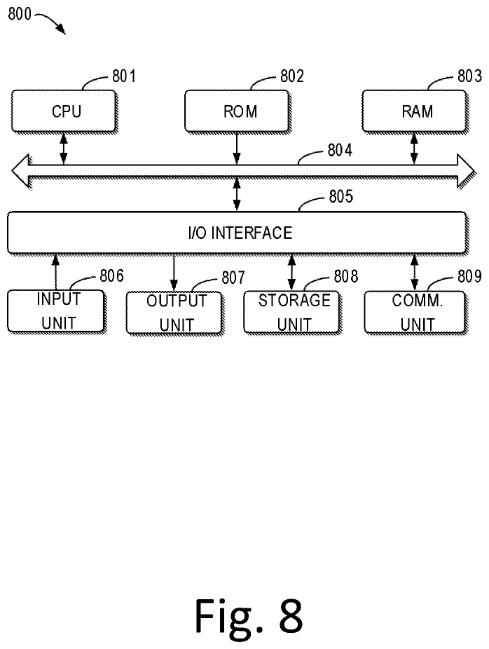

FIG. 8 is a schematic block diagram illustrating an example device 800 that can be used to implement embodiments of the present disclosure. As illustrated, the device 800 comprises a central processing unit (CPU) 801 which can perform various suitable acts and processing based on the computer program instructions stored in a read-only memory (ROM) 802 or computer program instructions loaded into a random access memory (RAM) 803 from a storage unit 808. The RAM 803 also stores various types of programs and data required by operating the storage device 800. CPU 801, ROM 802 and RAM 803 are connected to each other via a bus 804 to which an input/output (I/O) interface 805 is also connected.

Various components in the apparatus 800 are connected to the I/O interface 805, including: an input unit 806, such as a keyboard, mouse and the like; an output unit 807, such as a variety of types of displays, loudspeakers and the like; a storage unit 808, such as a magnetic disk, optical disk and the like; and a communication unit 809, such as a network card, modem, wireless communication transceiver and the like. The communication unit 809 enables the device 800 to exchange information/data with other devices via a computer network such as Internet and/or a variety of telecommunication networks.

The processing unit 801 performs various methods and processes as described above, for example, any of the processes 200 and 400. For example, in some embodiments, any of the processes 200 and 400 may be implemented as a computer software program or computer program product, which is tangibly included in a machine-readable medium, such as the storage unit 808. In some embodiments, the computer program can be partially or fully loaded and/or installed to the device 800 via ROM 802 and/or the communication unit 809. When the computer program is loaded to RAM 803 and executed by CPU 801, one or more steps of any of the processes 200 and 400 described above are implemented. Alternatively, in other embodiments, CPU 801 may be configured to implement any of the processes 200 and 400 in any other suitable manner (for example, by means of a firmware).

According to some embodiments of the present disclosure, there is provided a computer readable medium. The computer readable medium is stored with a computer program which, when executed by a processor, implements the method according to the present disclosure.

Those skilled in the art would understand that various steps of the method of the disclosure above may be implemented via a general-purpose computing device, which may be integrated on a single computing device or distributed over a network composed of a plurality of computing devices. Optionally, they may be implemented using program code executable by the computing device, such that they may be stored in a storage device and executed by the computing device; or they may be made into respective integrated circuit modules or a plurality of modules or steps therein may be made into a single integrated circuit module for implementation. In this way, the present disclosure is not limited to any specific combination of hardware and software.

It would be appreciated that although several means or sub-means of the apparatus have been mentioned in detailed description above, such partition is only example but not limitation. Actually, according to the embodiments of the present disclosure, features and functions of two or more apparatuses described above may be instantiated in one apparatus. In turn, features and functions of one apparatus described above may be further partitioned to be instantiated by various apparatuses.

What have been mentioned above are only some optional embodiments of the present disclosure and are not limiting the present disclosure. For those skilled in the art, the present disclosure may have various alternations and changes. Any modifications, equivalents and improvements made within the spirits and principles of the present disclosure should be included within the scope of the present disclosure.

I/We claim:

1. A method of handling congestion of data transmission, comprising:
determining whether congestion caused by a plurality of storage nodes occurs at a first port of a switch, the first port being connected to a first storage node, the plurality of storage nodes transmitting data to the first storage node via the first port of the switch;
in response to determining that the congestion occurs at the first port, selecting at least a second storage node from the plurality of storage nodes; and
updating configuration of a data transmission path for the second storage node, such that the second storage node transmits data to the first storage node while bypassing the first port.

2. The method of claim 1, wherein the determining whether the congestion occurs at the first port comprises:
determining whether a packet loss occurs at the first port based on an operation parameter of the first port;
in response to determining that the packet loss occurs, obtaining information on transmission control of the plurality of storage nodes; and
in response to the information indicating a delay in data transmission at at least one storage node from the plurality of storage nodes, determining that the congestion occurs at the first port.

3. The method of claim 2, wherein the information comprises a congestion window for the at least one storage node, and wherein the determining that the congestion occurs at the first port comprises:
in response to the congestion window being reduced, determining that the congestion occurs at the first port.

4. The method of claim 1, wherein selecting the second storage node from the plurality of storage nodes comprises:
determining data traffic transmitted from each of the plurality of storage nodes; and
selecting, from the plurality of storage nodes, a storage node with a highest data traffic as the second storage node.

5. The method of claim 1, wherein the updating the configuration comprises:
selecting a second port from a plurality of ports of the switch based on resource usage of the plurality of ports, the second port being connected to the first storage node and being different from the first port;
deactivating a connection of the second storage node to the first port; and
activating a connection of the second storage node to the second port, such that the second storage node transmits data to the first storage node via the second port.

6. The method of claim 1, wherein the updating the configuration comprises:
in response to a direct connection existing between the first storage node and the second storage node,
deactivating a connection between the second storage node and the switch; and
activating the direct connection between the second storage node and the first storage node, such that the second storage node transmits data to the first storage node directly.

7. The method of claim 1, wherein the updating the configuration comprises:
in response to a first direct connection existing between the first storage node and a third storage node and a second direct connection existing between the second storage node and the third storage node,
deactivating a connection between the second storage node and the switch; and
activating the first direct connection and the second direct connection, such that the third storage node relays data from the second storage node to the first storage node.

8. An electronic device, comprising:
a processor; and
a memory coupled to the processor, the memory having instructions stored therein, the instructions, when executed by the processor, causing the electronic device to perform acts comprising:
determining whether congestion caused by a plurality of storage nodes occurs at a first port of a switch, the first port being connected to a first storage node, the plurality of storage nodes transmitting data to the first storage node via the first port of the switch;
in response to determining that the congestion occurs at the first port, selecting at least a second storage node from the plurality of storage nodes; and
updating configuration of a data transmission path for the second storage node, such that the second storage node transmits data to the first storage node while bypassing the first port.

9. The electronic device of claim 8, wherein the determining whether the congestion occurs at the first port comprises:
determining whether a packet loss occurs at the first port based on an operation parameter of the first port;
in response to determining that the packet loss occurs, obtaining information on transmission control of the plurality of storage nodes; and
in response to the information indicating a delay in data transmission at at least one storage node from the plurality of storage nodes, determining that the congestion occurs at the first port.

10. The electronic device of claim 9, wherein the information comprises a congestion window for the at least one storage node, and wherein determining that the congestion occurs at the first port comprises:
in response to the congestion window being reduced, determining that the congestion occurs at the first port.

11. The electronic device of claim 8, wherein the selecting the second storage node from the plurality of storage nodes comprises:
determining data traffic transmitted from each storage node of the plurality of storage nodes; and
selecting, from the plurality of storage nodes, a storage node with the highest data traffic as the second storage node.

12. The electronic device of claim 8, wherein the updating the configuration comprises:
selecting a second port from a plurality of ports of the switch based on resource usage of the plurality of ports, the second port being connected to the first storage node and being different from the first port;
deactivating a connection of the second storage node to the first port; and
activating a connection of the second storage node to the second port, such that the second storage node transmits data to the first storage node via the second port.

13. The electronic device of claim 8, wherein the updating the configuration comprises:
in response to a direct connection existing between the first storage node and the second storage node,
deactivating a connection between the second storage node and the switch; and
activating the direct connection between the second storage node and the first storage node, such that the second storage node transmits data to the first storage node directly.

14. The electronic device of claim 8, wherein the updating the configuration comprises:
in response to a first direct connection existing between the first storage node and a third storage node and a second direct connection existing between the second storage node and the third storage node,
deactivating a connection between the second storage node and the switch; and
activating the first direct connection and the second direct connection, such that the third storage node relays data from the second storage node to the first storage node.

15. A computer program product, tangibly stored on a computer readable medium and comprising machine executable instructions which, when executed, cause a machine to perform operations, comprising:
determining whether congestion caused by a plurality of storage nodes occurs at a first port of a switch, the first port being connected to a first storage node, the plurality of storage nodes transmitting data to the first storage node via the first port of the switch;
in response to determining that the congestion occurs at the first port, selecting at least a second storage node from the plurality of storage nodes; and
updating configuration of a data transmission path for the second storage node, such that the second storage node transmits data to the first storage node while bypassing the first port.

16. The computer program product of claim 15, wherein the determining whether the congestion occurs at the first port comprises:
determining whether a packet loss occurs at the first port based on an operation parameter of the first port;
in response to determining that the packet loss occurs, obtaining information on transmission control of the plurality of storage nodes; and
in response to the information indicating a delay in data transmission at at least one storage node from the plurality of storage nodes, determining that the congestion occurs at the first port,
wherein the information comprises a congestion window for the at least one storage node, and wherein the determining that the congestion occurs at the first port comprises:
in response to the congestion window being reduced, determining that the congestion occurs at the first port.

17. The computer program product of claim 15, wherein the selecting the second storage node from the plurality of storage nodes comprises:
determining data traffic transmitted from each of the plurality of storage nodes; and
selecting, from the plurality of storage nodes, a storage node with the highest data traffic as the second storage node.

18. The computer program product of claim 15, wherein the updating the configuration comprises:
selecting a second port from a plurality of ports of the switch based on resource usage of the plurality of ports, the second port being connected to the first storage node and being different from the first port;
deactivating a connection of the second storage node to the first port; and
activating a connection of the second storage node to the second port, such that the second storage node transmits data to the first storage node via the second port.

19. The computer program product of claim 15, wherein the updating the configuration comprises:
in response to a direct connection existing between the first storage node and the second storage node,
deactivating a connection between the second storage node and the switch; and
activating the direct connection between the second storage node and the first storage node, such that the second storage node transmits data to the first storage node directly.

20. The computer program product of claim 15, wherein the updating the configuration comprises:
in response to a first direct connection existing between the first storage node and a third storage node and a second direct connection existing between the second storage node and the third storage node,
deactivating a connection between the second storage node and the switch; and
activating the first direct connection and the second direct connection, such that the third storage node relays data from the second storage node to the first storage node.
